(19) United States
(12) Patent Application Publication
(10) Pub. No.: US 2022/0004185 A1
(43) Pub. Date: Jan. 6, 2022

(54) VEHICLE CONTROL SYSTEM AND REMOTE CONTROL METHOD OF VEHICLE

(71) Applicants: HYUNDAI MOTOR COMPANY, Seoul (KR); KIA MOTORS CORPORATION, Seoul (KR)

(72) Inventor: Chung Tae Kim, Seoul (KR)

(21) Appl. No.: 17/083,948

(22) Filed: Oct. 29, 2020

(30) Foreign Application Priority Data
Jul. 3, 2020 (KR) 10-2020-0081974

(51) Int. Cl. G05D 1/00; H04W 4/80; H04W 4/40; G05D 1/02; B60W 30/06; B60Q 1/50

(52) U.S. Cl. CPC G05D 1/0016; H04W 4/80; H04W 4/40; B60W 2556/45; B60W 30/06; B60Q 1/50; G05D 1/0276

(57) ABSTRACT

In accordance with one aspect of the disclosure, a vehicle control system includes a user terminal, a server and a vehicle. The user terminal is configured to transmit user information to a Near Field Communication (NFC) device of the vehicle after an application execution, the server is configured to transmit vehicle movement information input from the user terminal to the vehicle when the user information transmitted from the vehicle is confirmed as pre-registered user information, and the vehicle is configured to move based on the vehicle movement information when a movement command is received.

### CROSS-REFERENCE TO RELATED APPLICATION

This application is based on and claims priority under 35 U.S.C. § 119 to Korean Patent Application No. 10-2020-0081974, filed on Jul. 3, 2020 in the Korean Intellectual Property Office, the disclosure of which is incorporated herein by reference.

### TECHNICAL FIELD

The disclosure relates to a vehicle control system for remotely moving a double parked vehicle and a remote control method of the vehicle.

### BACKGROUND

Double parking frequently occurs in areas with a large population and insufficient parking space. The driver of a double parking vehicle usually places the gear in neutral so that others can push out the double parked vehicle. However, due to the weight of the vehicle, it is difficult to easily push the vehicle, and an accident may occur while pushing the double parked vehicle.

Since the latest vehicle includes an electronic parking brake and an auto-hold function, a situation in which the vehicle cannot be pushed out may occur even if the gear is in neutral. In this case, a driver who is unable to leave due to the double parking vehicle may feel uncomfortable. The driver of the exit vehicle needs to contact the owner of the double parking vehicle to request the movement of the vehicle, but considerable inconvenience occurs when the owner of the double parking vehicle is not nearby.

In addition, recently, a vehicle including a function of allowing a driver to park remotely after getting off has been released. However, there is no technology capable of moving a vehicle other than the owner of the vehicle.

### SUMMARY

Therefore, it is an aspect of the present disclosure to provide a vehicle control system capable of easily and safely moving a double parked vehicle and a remote control method of the vehicle.

In accordance with one aspect of the disclosure, a vehicle control system includes a user terminal, a server and a vehicle. The user terminal is configured to transmit user information to a Near Field Communication (NFC) device of the vehicle after an application execution, the server is configured to transmit vehicle movement information input from the user terminal to the vehicle when the user information transmitted from the vehicle is confirmed as pre-registered user information, and the vehicle is configured to move based on the vehicle movement information when a movement command is received.

The server may be configured to receive a movement approval request together with a confirmation request of the user information from the vehicle, transmit a movement approval message to the vehicle when the user information is confirmed as the pre-registered user information, and request input of the vehicle movement information to the user terminal.

The vehicle may be configured to inform the movement preparation completion by lighting an indicator provided on a door of the vehicle when the movement approval message is received.

The vehicle may be configured to receive the movement command through the touch sensor provided on a door of the vehicle.

The vehicle movement information may include a movement direction and a movement distance, and the vehicle may be configured to move in the movement direction by the movement distance when a user's touch is input to the touch sensor at a predetermined number of times corresponding to the movement direction.

The vehicle may be configured to turn on ignition and release parking brake when the movement command is received.

The vehicle may be configured to switch to a standby state after the movement is completed and blink an indicator provided on a door of the vehicle.

The vehicle may be configured to further move based on the vehicle movement information when an additional movement command is received within a predetermined waiting time.

The vehicle may be configured to turn off ignition and engage parking brake after the predetermined waiting time has elapsed when the additional movement command is not received and transmit a movement completion signal to the server.

The vehicle may be configured to immediately turn off ignition and engage parking brake after completing the additional movement and transmit a movement completion signal to the server.

In accordance with one aspect of the disclosure, a remote control method of a vehicle performed by a user terminal, a server and the vehicle, the remote control method includes: obtaining user information from the user terminal through a Near Field Communication (NFC) device of the vehicle, and requesting confirmation of the user information to the server; identifying, by the server, whether the user information is a pre-registered user information; receiving vehicle movement information from the user terminal when the user information is confirmed as the pre-registered user information; transmitting, by the server, the vehicle movement information to the vehicle; receiving, by the vehicle, a movement command; and controlling movement of the vehicle based on the vehicle movement information.

The remote control method may further include: transmitting a movement approval message to the vehicle when the user information is confirmed as the pre-registered user information, and the requesting confirmation of the user information may include: transmitting a movement approval request to the server.

The remote control method may further include: informing the movement preparation completion by lighting an indicator provided on a door of the vehicle when the vehicle receives the movement approval message.

The receiving the movement command may include: receiving the movement command by a touch sensor provided on a door of the vehicle.

The vehicle movement information may include a movement direction and a movement distance, and the controlling movement of the vehicle may include: moving the vehicle in the movement direction by the movement distance when a user's touch is input to the touch sensor at a predetermined number of times corresponding to the movement direction.

The controlling movement of the vehicle may include: turning on ignition of the vehicle and releasing parking brake when the movement command is received.

The controlling movement of the vehicle may include: switching to a standby state after the movement of the vehicle is completed and blinking an indicator provided on a door of the vehicle.

The controlling movement of the vehicle may include: controlling an additional movement of the vehicle based on the vehicle movement information when an additional movement command is received within a predetermined waiting time.

The controlling movement of the vehicle may include: turning off ignition and engaging parking brake after the predetermined waiting time has elapsed when the additional movement command is not received; and transmitting a movement completion signal to the server.

The controlling movement of the vehicle may include: immediately turning off the ignition and engaging the parking brake after completing the additional movement; and transmitting a movement completion signal to the server.

In accordance with one aspect of the disclosure, a vehicle includes a Near Field Communication (NFC) device disposed at a door of the vehicle and configured to receive user information from an NFC tag embedded in a user terminal; a transceiver configured to transmit the user information to a server; and a controller configured to cause an indicator provided on the door to indicate movement preparation completion, in response to receiving a first signal from the server indicating that the user information is pre-registered. The transceiver may be further configured to receive from the server a second signal indicating movement information, and the controller may be further configured to control the vehicle to move based on a movement command received through a touch sensor provided on the door.

### BRIEF DESCRIPTION OF THE DRAWINGS

These and/or other aspects of the disclosure will become apparent and more readily appreciated from the following description of the embodiments, taken in conjunction with the accompanying drawings of which:

FIGS. 1 and 2 illustrate a situation in which a double parked vehicle is present;

FIG. 3 illustrates a vehicle control system according to an embodiment;

FIG. 4 illustrates a configuration of a vehicle according to an embodiment;

FIG. 5 illustrates an exterior of a vehicle according to an embodiment;

FIG. 6 illustrates an indicator and a touch sensor provided in the vehicle;

FIGS. 7 and 8 are flowcharts illustrating a remote control method of vehicle according to an embodiment; and

FIGS. 9 and 10 illustrate screens displayed on a user terminal to perform remote control of a vehicle.

### DETAILED DESCRIPTION

Like reference numerals refer to like elements throughout the specification. Not all elements of embodiments of the disclosure will be described, and description of what are commonly known in the art or what overlap each other in the embodiments will be omitted.

It will be understood that when an element is referred to as being “connected” to another element, it can be directly or indirectly connected to the other element, wherein the indirect connection includes “connection” via a wireless communication network.

Also, when a part “includes” or “comprises” an element, unless there is a particular description contrary thereto, the part may further include other elements, not excluding the other elements.

As used herein, the singular forms “a,” “an” and “the” are intended to include the plural forms as well, unless the context clearly indicates otherwise.

As used herein, the terms “portion,” “unit,” “block,” “member,” and “module” refer to a unit that can perform at least one function or operation. For example, these terms may refer to at least one process which is performed by at least one piece of hardware such as a field-programmable gate array (FPGA) and an application specific integrated circuit (ASIC), and at least one piece of software stored in a memory and/oror a processor configured to perform operations thereof when executing the at least one piece of software.

An identification code is used for the convenience of the description but is not intended to illustrate the order of each step. Each of the steps may be implemented in an order different from the illustrated order unless the context clearly indicates otherwise.

Hereinafter, exemplary embodiments of the present invention will be described in detail with reference to the accompanying drawings.

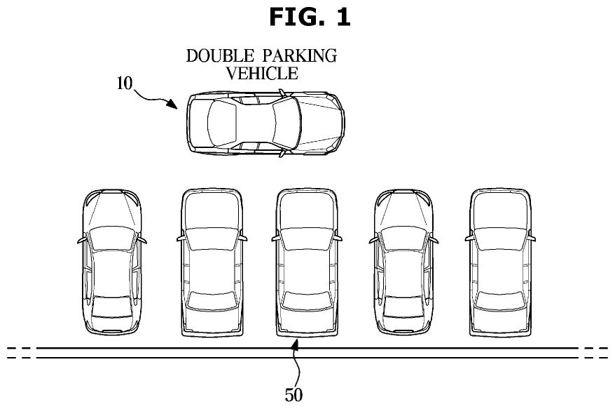

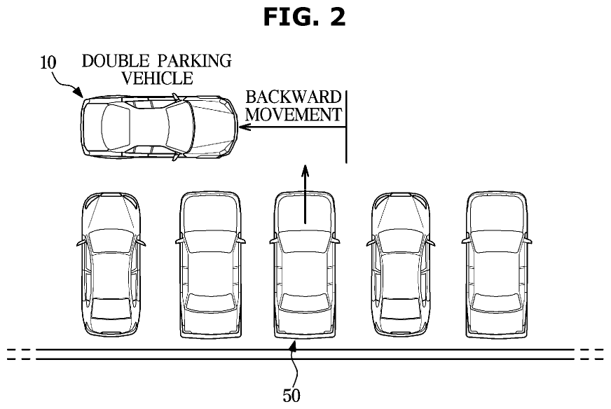

FIGS. 1 and 2 illustrate a situation in which a double parked vehicle is present.

Referring to FIGS. 1 and 2, the exit vehicle 50 is in a situation where the exit cannot be performed due to the double parking vehicle 10. In this case, the driver of the exit vehicle 50 may push the double parking vehicle 10 forward or backward and then exit.

When the parking brake of the double parking vehicle 10 is released, the driver of the vehicle 50 will be able to manually push the double parking vehicle 10 and exit. However, pushing the double parking vehicle 10 may not be easy, and an accident may occur while pushing the double parking vehicle.

In addition, due to the electronic parking brake and auto-hold function of the double parking vehicle 10, it may be impossible to manually move the double parking vehicle 10. In this case, a driver who is unable to leave due to the double parking vehicle 10 may feel uncomfortable. The driver of the exit vehicle 50 needs to contact the owner of the double parking vehicle to request the movement of the vehicle. However, considerable inconvenience occurs when the owner of the double parking vehicle 10 is not nearby.

Therefore, there is a need for a technology that allows the driver of the exit vehicle 50 to move the double parking vehicle 10 easily and safely.

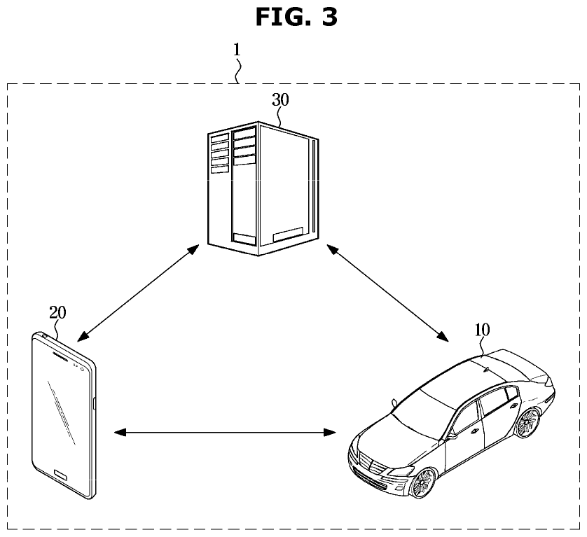

FIG. 3 illustrates a vehicle control system according to an embodiment.

Referring to FIG. 3, a vehicle control system 1 according to an embodiment may include a vehicle 10, a user terminal 20 and a server 30. The vehicle 10 means a vehicle that is double parked. The user terminal 20 may be a mobile device owned by a user of the exit vehicle 50.

The vehicle 10, the user terminal 20, and the server 30 may communicate with each other. The vehicle 10, the user terminal 20, and the server 30 may transmit and receive data using wireless communication or wired communication. The server 30 may also communicate directly with each of the user terminal 20 and vehicle 10. The vehicle 10 and the user terminal 20 may also communicate directly with each other.

Wireless communication may include cellular communication using 5G (5th Generation), LTE, LTE Advance (LTE-A), Code Division Multiple Access (CDMA), Wideband CDMA (WCDMA), Universal Mobile Telecommunications System (UMTS), wireless broadband (WiBro), or Global System for Mobile communications (GSM).

In addition, wireless communication may include wireless fidelity (WiFi), Bluetooth, Bluetooth low power (BLE), zigbee, near field communication (NFC), magnetic secure transmission, radio frequency (RF), or body area network. (BAN).

In addition, wireless communication may include GNSS. The GNSS may be a Global Positioning System (GPS), a global navigation satellite system (Glonass), a beidou navigation satellite system (hereinafter “Beidou”) or a galileo, the european global satellite-based navigation system.

Wired communication may include Universal Serial Bus (USB) communication, High Definition Multimedia Interface (HDMI), Recommended Standard-232 (RS-232), power line communication, or Plain Old Telephone Service (POTS) communication.

The user terminal 20 may mean a mobile device possessed by a user. The mobile device is easy to carry and portable electronic devices, such as video phones, mobile phones, smart phones, WCDMA (Wideband Code Division Multiple Access) devices, UMTS (Universal Mobile Telecommunication Service) devices, Personal Digital Assistant (PDA) devices, Portable Multimedia Player (PMP), Digital Multimedia Broadcasting (DMB) device, E-Book, portable computing devices or a digital camera.

The server 30 may include a processor and memory as computing devices. In addition, the server 30 may include a communication device. The communication device may be a device to which the aforementioned communication technologies are applied. The user terminal 20 may also include a processor, memory, and communication device. In addition, the user terminal 20 may include a display.

The server 30 may store programs, instructions, and/or applications for executing a remote control method of a vehicle. An application and/or program for executing a remote control method of a vehicle may be installed in each of the vehicle 10 and the user terminal 20. The user terminal 20 may receive and install an application from the server 30.

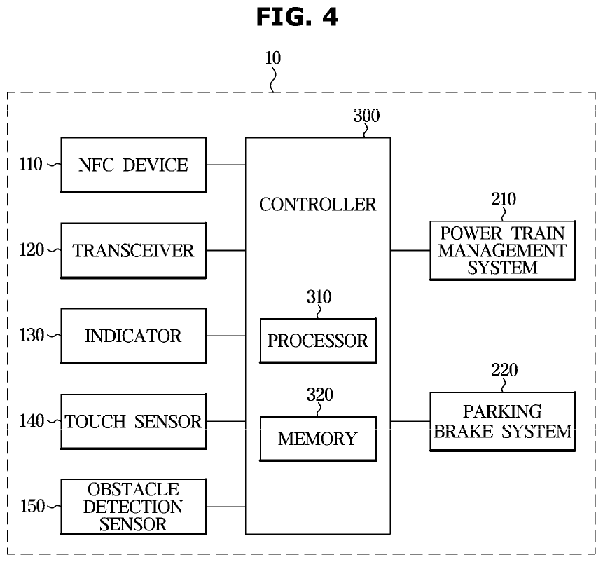

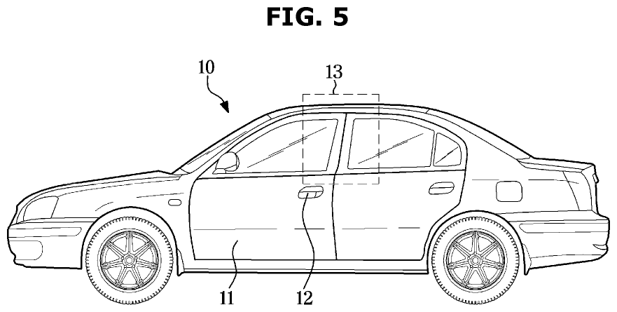

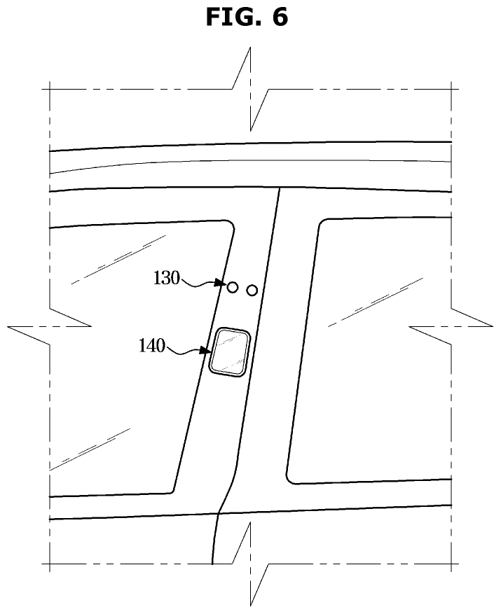

FIG. 4 illustrates a configuration of a vehicle according to an embodiment. FIG. 5 illustrates an exterior of a vehicle according to an embodiment. FIG. 6 illustrates an indicator and a touch sensor provided in the vehicle.

Referring to FIG. 4, the vehicle 10 according to an embodiment includes an NFC device 110, a transceiver 120, an indicator 130, a touch sensor 140, an obstacle detection sensor 150, and a power train management system 210, a parking brake system 220 and a controller 300.

Near Field Communication (NFC) device 110 is a device that performs short-range wireless communication. NFC device 110 may be provided on the door handle 12 of the vehicle 10. The door handle 12 means a handle provided on the outer surface of the door 11. In other terms, the door handle 12 may be referred to as an outside handle. The installation position of the NFC device 110 is not limited to the door handle 12. NFC device 110 may be installed in various locations on the exterior of the vehicle 10.

The NFC device 110 may obtain information included in the NFC tag by reading the NFC tag when the NFC tag is within a predetermined reception range. For example, the NFC device 110 of the vehicle 10 may obtain user information from an NFC tag embedded in the user terminal 20 when the user terminal 20 is in proximity. The user information may include a name and a phone number. When the user terminal 20 is close to the door handle 12 in a state in which an application for remote control of the vehicle is executed, the NFC device 110 embedded in the door handle 12 may obtain user information.

The transceiver 120 may communicate with external devices of the vehicle 10. As described above, the transceiver 120 may communicate with each of the user terminal 20 and the server 30.

Referring to FIGS. 5 and 6, the indicator 130 may be provided on the door 11. For example, the indicator 130 may be provided on the B-pillar 13 of the door 11. B-pillar 13 may be defined as a pillar between the front door and the rear door. The installation position of the indicator 130 is not limited to the B-pillar 13 of the door 11. The indicator 130 may be installed at various locations on the exterior of the vehicle 10.

The indicator 130 may be implemented as a light emitting diode (LED). For example, the indicator 130 may include a red LED and a blue LED. The indicator 130 may emit light in various patterns under control of the controller 300. When the vehicle 10 is ready to move, both the red LED and the blue LED of the indicator 130 are turned on to emit light. In addition, when the movement of the vehicle 10 is completed, both the red LED and the blue LED of the indicator 130 may blink (repeating light on and off). When the vehicle 10 moves forward, only the red LED of the indicator 130 emits light, and when the vehicle 10 moves backward, only the blue LED of the indicator 130 emits light.

The touch sensor 140 may receive a movement command for moving the vehicle 10 from the user. That is, the touch sensor 140 may receive a user's touch input. The touch sensor 140 may be provided together with the indicator 130 in the B-pillar 13 of the door 11. The installation position of the touch sensor 140 is not limited to the B-pillar 13 of the door 11. The touch sensor 140 may be installed at various locations on the exterior of the vehicle 10.

The obstacle detection sensor 150 may detect an obstacle around the vehicle 10. The obstacle detection sensor 150 may include at least one of an ultrasonic sensor, a radar, a lidar, or a camera. When the surrounding obstacle is detected by the obstacle detection sensor 150 while the vehicle 10 is moving, the vehicle 10 may stop moving.

The powertrain management system 210 includes devices that drive the power unit of the vehicle 10 and transmit power generated by the power unit to the wheel of the vehicle 10. When a movement command is received through the touch sensor 140, the powertrain management system 210 may generate power required for the movement of the vehicle 10 by turning on the starting of the vehicle 10. The controller 300 may control the powertrain management system 210 to control the movement of the vehicle 10.

The parking brake system 220 includes devices that allow the stationary state of the vehicle 10 to be maintained during parking. For example, the parking brake system 220 may include at least one of a parking brake or parking gear. The parking brake may be an electric parking brake (EPB). When a movement command is received through the touch sensor 140, the parking brake system 220 may release the parking brake. Therefore, the vehicle 10 becomes movable. The parking brake system 220 may release the parking brake or engage the parking brake under the control of the controller 300.

The controller 300 is electrically connected to electronic devices of the vehicle 10 to control each device. The controller 300 may include a processor 310 and a memory 320. The memory 320 may store programs, instructions, and/or applications for performing a remote control method of vehicle. The processor 310 may execute programs, instructions, and/or applications stored in the memory 320. The processor 310 and the memory 320 may be provided in plural. The controller 300 may include an electronic control unit (ECU), a micro controller unit (MCU), and the like.

The memory 320 may include non-volatile memory element such as cache, read only memory (ROM), programmable ROM (PROM), erasable programmable ROM (EPROM), electrically erasable programmable ROM (EEPROM), and flash memory. Further, the memory 320 may include a volatile memory element such as random access memory (RAM), and may include a storage medium such as a hard disk drive (HDD) or a CD-ROM. The type of memory 220 is not limited to that illustrated.

In addition to the above-described configurations, the vehicle 10 may include various devices. Hereinafter, the operation of the vehicle control system according to an embodiment will be described in detail.

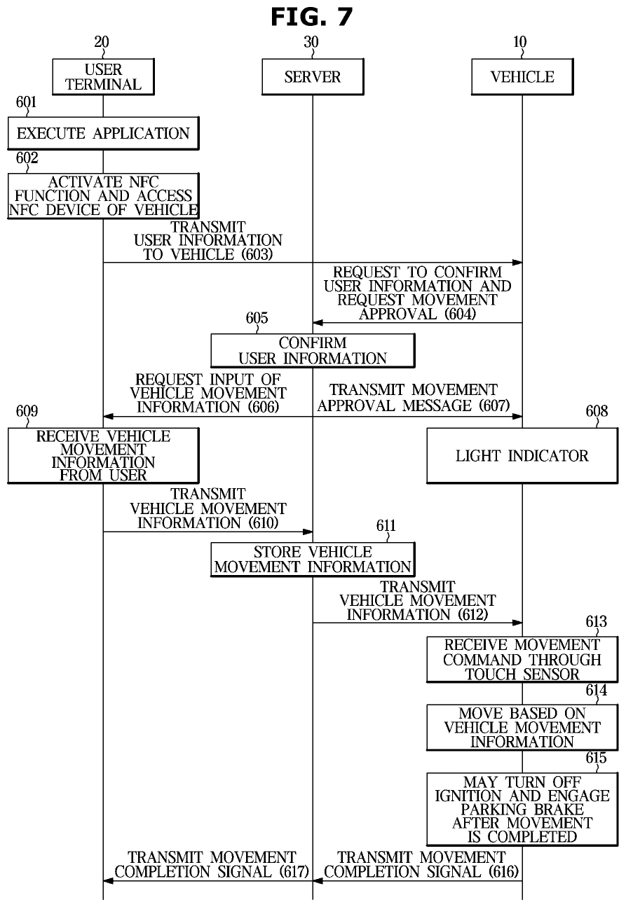

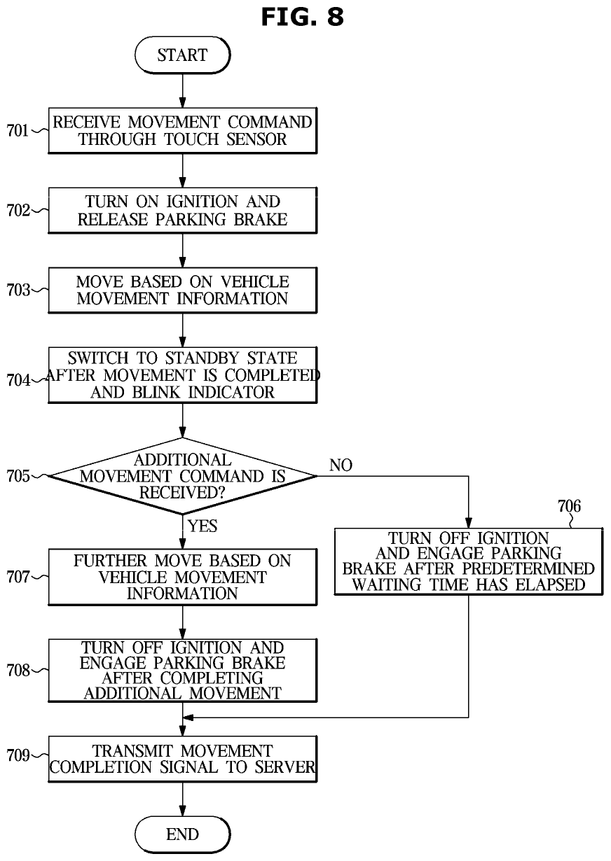

FIGS. 7 and 8 are flowcharts illustrating a remote control method of vehicle according to an embodiment.

Referring to FIG. 7, first, the user terminal 20 may execute an application for remote control of the vehicle 10 (601). Execution of the application may include performing an user authentication procedure. The authentication process includes at least one of signing up or logging in. The user terminal 20 may access the server 30 through a user authentication procedure. The server 30 may record the connection history of the user terminal 20.

The user terminal 20 may activate the NFC function after the application is executed and access the NFC device 110 of the vehicle 10 (602). The user terminal 20 may transmit user information to the NFC device 110 of the vehicle 10 (603). The user information may include a name and a phone number.

The vehicle 10 may request the server 30 to confirm the user information received from the user terminal 20. Also, the vehicle 10 may request movement approval to the server 30 (604).

The server 30 confirms user information transmitted from the vehicle 10 (605). That is, the server 30 confirms whether user information is pre-registered user information. When the user information is confirmed as pre-registered user information, the server 30 may request input of vehicle movement information to the user terminal 20 (606).

When the user information transmitted from the vehicle 10 does not correspond to the pre-registered user information, the server 30 may transmit a connection blocking signal to the vehicle 10 and the user terminal 20. That is, a user who is not registered in the server 30 cannot move the vehicle 10.

In addition, when the user information is confirmed as pre-registered user information, the server 30 may transmit a movement approval message to the vehicle 10 (607). When the movement approval message is received, the vehicle 10 may light the indicator 130 provided on the door 11 to inform the movement preparation completion (608). When the vehicle 10 is ready to move, both the red LED and the blue LED included in the indicator 130 are turned on to emit light.

The user terminal 20 may receive vehicle movement information from a user (609). The user terminal 20 transmits vehicle movement information to the server 30 (610), and the server 30 stores vehicle movement information (611). The server 30 transmits vehicle movement information to the vehicle 10 (612). Vehicle movement information includes movement direction and movement distance. For example, the user may input the movement direction as forward and the movement distance as 2 m. The user terminal 20 may display a user interface (UI) for inputting vehicle movement information on a screen.

The vehicle 10 may receive a movement command through the touch sensor 140 provided on the door 11 (613). The vehicle 10 may move based on vehicle movement information when a movement command is received (614). The vehicle 10 may move after turning on the ignition and releasing the parking brake when a movement command is received.

Specifically, when the user's touch is input to the touch sensor 140 at a predetermined number of times corresponding to the movement direction, the vehicle 10 may move by the movement distance in the movement direction. For example, the movement command for moving the vehicle 10 forward may be that two user touches are continuously input to the touch sensor 140. The movement command for moving the vehicle 10 backward may be that three user touches are continuously input to the touch sensor 140.

By setting a movement command corresponding to the movement direction in advance, it is possible to prevent a user's mistake of moving the vehicle 10.

Meanwhile, when the vehicle 10 moves forward, only the red LED of the indicator 130 emits light, and when the vehicle 10 moves backward, only the blue LED of the indicator 130 emits light. In addition, the direction indicator lamp of the vehicle 10 may blink while the vehicle 10 is moving.

When the movement is completed, the vehicle 10 may turn off the ignition and engage the parking brake (615). When the movement of the vehicle 10 is completed, both the red LED and the blue LED of the indicator 130 may blink (repeating light on and off).

Subsequently, the vehicle 10 may transmit a movement completion signal to the server 30 (616). The server 30 may record the time when the movement is completed. The server 30 may transmit the received movement completion signal to the user terminal 20.

Also, the server 30 may transmit a movement completion signal to a mobile device owned by the owner of the vehicle 10. Through this, the owner of the vehicle 10 may recognize that his vehicle has been moved by another person.

Referring to FIG. 8, the vehicle 10 may receive a movement command through the touch sensor 140 provided on the door 11 (701), turn on the ignition and releases the parking brake (702), and move based on the vehicle movement information (703).

The vehicle 10 may switch to a standby state after the movement is completed, and blink the indicator 130 provided on the door 11 (704). The blinking of the indicator 130 is a signal informing the user that the vehicle 10 is in a standby state. Switching the vehicle 10 to the standby state is for receiving additional movement commands.

When an additional movement command is received within a predetermined waiting time, the vehicle 10 may further move based on vehicle movement information (705, 707). The vehicle 10 immediately turns off the ignition after completing the additional movement and engages the parking brake (708).

However, when no further movement command is received, the vehicle 10 may turn off the ignition and engage the parking brake after a predetermined waiting time has elapsed (706).

The vehicle 10 may transmit a movement completion signal to the server 30 after turning off the ignition and engaging the parking brake (709).

Meanwhile, the number of additional movements may be limited. In addition, the total number of movements of the vehicle 10 may also be limited. This is because if there is no limitation on the movement of the vehicle 10, there is a danger that the vehicle 10 is moved to an unintended place. For example, the number of additional movements may be limited to one, and the total number of movements may be limited to five. Also, the maximum distance that may be moved may be limited.

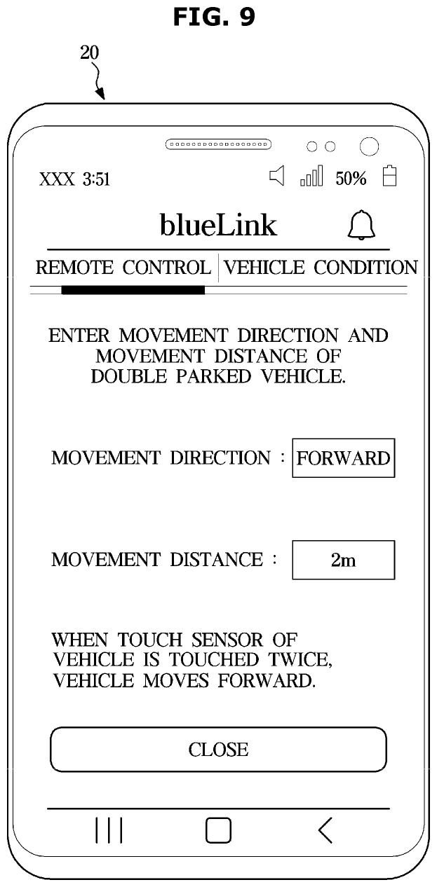

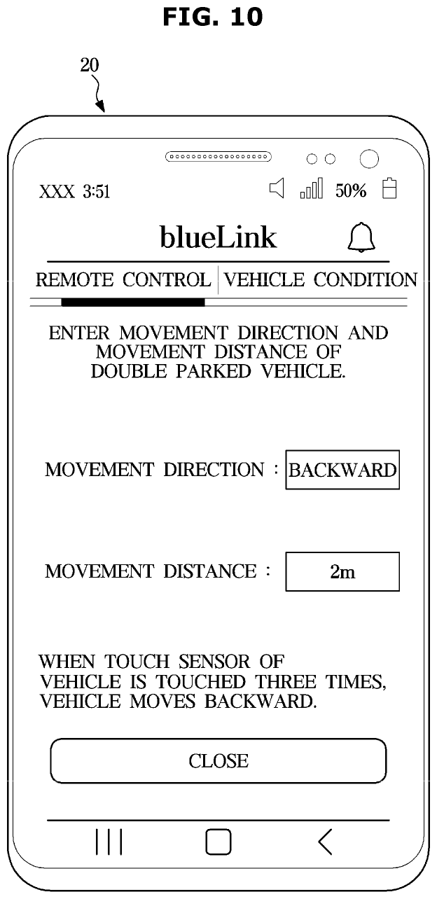

FIGS. 9 and 10 illustrate screens displayed on a user terminal to perform remote control of a vehicle.

Referring to FIGS. 9 and 10, the user terminal 20 may display a user interface (UI) for inputting vehicle movement information on a screen. The user terminal 20 may display a UI element capable of inputting a movement direction and movement distance. The movement direction may be selected either forward or backward. The movement distance may be input in meters.

In addition, the user terminal 20 may display a guide message regarding a movement command for moving the vehicle 10. In FIG. 9, since the movement direction is set to the forward, it is exemplified that a guide message such as “When the touch sensor of the vehicle is touched twice, the vehicle moves forward” is displayed on the display of the user terminal 20.

In FIG. 10, since the movement direction is set to the backward, it is exemplified that a guide message such as “ When the touch sensor of the vehicle is touched three times, the vehicle moves backward ” is displayed on the display of the user terminal 20.

In this way, the user terminal 20 displays the guide message, so that the user may easily input the movement command of the vehicle 10.

The disclosed vehicle control system and remote control method of the vehicle can move a double parked vehicle easily and safely. The disclosed vehicle control system and the remote control method of the vehicle enable the driver of the exit vehicle, rather than the owner of the double parked vehicle, to move the double parked vehicle, so that problems caused by the double parking can be solved.

Meanwhile, the disclosed embodiments may be implemented in the form of a recording medium storing instructions that are executable by a computer. The instructions may be stored in the form of a program code, and when executed by a processor, the instructions may generate a program module to perform operations of the disclosed embodiments. The recording medium may be implemented as a computer-readable recording medium.

The computer-readable recording medium may include all kinds of recording media storing commands that can be interpreted by a computer. For example, the computer-readable recording medium may be ROM, RAM, a magnetic tape, a magnetic disc, flash memory, an optical data storage device, etc.

The exemplary embodiments of the disclosure have thus far been described with reference to the accompanying drawings. It will be obvious to those of ordinary skill in the art that the disclosure may be practiced in other forms than the exemplary embodiments as described above without changing the technical idea or essential features of the disclosure. The above exemplary embodiments are only by way of example, and should not be interpreted in a limited sense.

What is claimed is:

1. A vehicle control system comprising a user terminal, a server and a vehicle,
wherein the user terminal is configured to transmit user information to a Near Field Communication (NFC) device of the vehicle after an application execution,
the server is configured to transmit vehicle movement information input from the user terminal to the vehicle when the user information transmitted from the vehicle is confirmed as pre-registered user information, and
the vehicle is configured to move based on the vehicle movement information when a movement command is received.

2. The vehicle control system according to claim 1, wherein the server is configured to receive a movement approval request together with a confirmation request of the user information from the vehicle, transmit a movement approval message to the vehicle when the user information is confirmed as the pre-registered user information, and request input of the vehicle movement information to the user terminal.

3. The vehicle control system according to claim 2, wherein the vehicle is configured to inform movement preparation completion by lighting an indicator provided on a door of the vehicle when the movement approval message is received.

4. The vehicle control system according to claim 1, wherein the vehicle is configured to receive the movement command through a touch sensor provided on a door of the vehicle.

5. The vehicle control system according to claim 4, wherein the vehicle movement information comprises a movement direction and a movement distance, and
wherein the vehicle is configured to move in the movement direction by the movement distance when a user's touch is input to the touch sensor at a predetermined number of times corresponding to the movement direction.

6. The vehicle control system according to claim 1, wherein the vehicle is configured to turn on ignition and release parking brake when the movement command is received.

7. The vehicle control system according to claim 1, wherein the vehicle is configured to switch to a standby state after the movement is completed and blink an indicator provided on a door of the vehicle.

8. The vehicle control system according to claim 7, wherein the vehicle is configured to further move based on the vehicle movement information when an additional movement command is received within a predetermined waiting time.

9. The vehicle control system according to claim 8, wherein the vehicle is configured to turn off ignition and engage parking brake after the predetermined waiting time has elapsed when the additional movement command is not received and transmit a movement completion signal to the server.

10. The vehicle control system according to claim 8, wherein the vehicle is configured to immediately turn off ignition and engage parking brake after completing the additional movement and transmit a movement completion signal to the server.

11. A remote control method of a vehicle performed by a user terminal, a server and the vehicle, the remote control method comprises:
obtaining user information from the user terminal through a Near Field Communication (NFC) device of the vehicle, and requesting confirmation of the user information to the server;
identifying, by the server, whether the user information is a pre-registered user information;
receiving vehicle movement information from the user terminal when the user information is confirmed as the pre-registered user information;
transmitting, by the server, the vehicle movement information to the vehicle;
receiving, by the vehicle, a movement command; and
controlling movement of the vehicle based on the vehicle movement information.

12. The remote control method according to claim 11, further comprising:
transmitting a movement approval message to the vehicle when the user information is confirmed as the pre-registered user information,
wherein the requesting confirmation of the user information comprises:
transmitting a movement approval request to the server.

13. The remote control method according to claim 12, further comprising:
informing movement preparation completion by lighting an indicator provided on a door of the vehicle when the vehicle receives the movement approval message.

14. The remote control method according to claim 11, wherein the receiving the movement command comprises:
receiving the movement command by a touch sensor provided on a door of the vehicle.

15. The remote control method according to claim 14, wherein the vehicle movement information comprises a movement direction and a movement distance, and
wherein the controlling movement of the vehicle comprises:
moving the vehicle in the movement direction by the movement distance when a user's touch is input to the touch sensor at a predetermined number of times corresponding to the movement direction.

16. The remote control method according to claim 11, wherein the controlling movement of the vehicle comprises:
turning on ignition of the vehicle and releasing parking brake when the movement command is received.

17. The remote control method according to claim 11, wherein the controlling movement of the vehicle comprises:
switching to a standby state after the movement of the vehicle is completed and blinking an indicator provided on a door of the vehicle.

18. The remote control method according to claim 17, wherein the controlling movement of the vehicle comprises:
controlling an additional movement of the vehicle based on the vehicle movement information when an additional movement command is received within a predetermined waiting time.

19. The remote control method according to claim 18, wherein the controlling movement of the vehicle comprises:
turning off ignition and engaging parking brake after the predetermined waiting time has elapsed when the additional movement command is not received; and
transmitting a movement completion signal to the server.

20. The remote control method according to claim 18, wherein the controlling movement of the vehicle comprises:
immediately turning off ignition and engaging parking brake after completing the additional movement; and
transmitting a movement completion signal to the server.

21. A vehicle, comprising:
a Near Field Communication (NFC) device disposed at a door of the vehicle and configured to receive user information from an NFC tag embedded in a user terminal;
a transceiver configured to transmit the user information to a server; and
a controller configured to cause an indicator provided on the door to indicate movement preparation completion, in response to receiving a first signal from the server indicating that the user information is pre-registered,
wherein the transceiver is further configured to receive from the server a second signal indicating movement information, and
the controller is further configured to control the vehicle to move based on a movement command received through a touch sensor provided on the door.
